(19) United States
(12) Patent Application Publication
(10) Pub. No.: US 2005/0276069 A1
(43) Pub. Date: Dec. 15, 2005

(54) Liquid crystal display apparatus

(76) Inventors: Hitoshi Taniguchi, Yokohama (JP); Tsunenori Yamamoto, Hitachi (JP); Ikuo Hiyama, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/126,158

(22) Filed: May 11, 2005

(30) Foreign Application Priority Data
May 11, 2004 (JP) 2004-140931

(51) Int. Cl. G02F 1/1335

(52) U.S. Cl. 362/600

(57) ABSTRACT

A liquid crystal display apparatus having a diffusion plate and/or a prism sheet disposed between a liquid crystal display device and a plurality of light emission portions. Each light emission portion is constituted by an optical guide and one or more light emitting devices. The optical guide has a light reflection surface formed in a substrate and a light transmission surface brought into tight contact with the light reflection surface. The light emitting devices are integrated with the optical guide. Then, the light reflection surface is a scatter reflection surface, and an average angle between the light reflection surface and the light transmission surface is set to range from 7° to 23°. Thus, obtained is a thin-type liquid crystal display apparatus high in luminance of light outgoing to the front surface of the display apparatus and superior in uniformity of outgoing angle distribution or luminance distribution.

### FIELD OF THE INVENTION

The present invention relates to a thin-type liquid crystal display apparatus which has a direct-under type backlight and is superior in high luminance, outgoing angle distribution uniformity, luminance distribution uniformity, and luminance distribution controllability.

In recent years, large screen type liquid crystal display apparatus such as liquid crystal television (TV) receivers have been lower in price. As a result, these apparatus have been in widespread use. These liquid crystal display apparatus require higher luminance than personal computer (PC) liquid crystal display apparatus. To this end, liquid crystal display apparatus using a direct-under type backlight as a light source, chiefly using a cold-cathode tube as a light source, have been used.

The direct-under type backlight has a structure as disclosed in FIG. 6 of the following Patent Document 1. That is, the direct-under type backlight is constituted by a casing, a diffusion plate serving as a light emission surface, a light source inside the casing, an optical sheet put on the surface of the diffusion plate, etc. Light from the light source is reflected repeatedly inside the casing, and emitted from the surface of the diffusion plate with a substantially uniform distribution due to optimization of the layout of the diffusion plate and the light source, or the like. In addition, a flat light source of collimated light using a micro-lens array is disclosed in the following Patent Document 2.

Patent Document 1:
Japanese Patent Laid-Open No. 2003-234012

Patent Document 2:
Japanese Patent Laid-Open No. 2002-49326

### SUMMARY OF THE INVENTION

As for the performance requested to a liquid crystal TV backlight, the quantity of light with which a liquid crystal panel is irradiated has to be large, and the whole surface of the light crystal panel has to be irradiated with the light with a uniform luminance and with a uniform outgoing angle distribution.

Generally, the thickness of the liquid crystal panel is only several millimeters. Therefore, the thickness of the liquid crystal display apparatus depends on the thickness of the backlight. Thus, in order to make the liquid crystal display apparatus thinner, it is essential to make the backlight thinner.

As for the luminance, typically, the luminance of the liquid crystal TV backlight has to be five or more times as high as that of a notebook PC backlight. Therefore, a direct-under type backlight is generally used. The quantity of irradiation with light can be enhanced easily by increasing the quantity of light radiated from the light source. However, the power consumption also increases. Thus, this method cannot be regarded as a realistic method.

As shown in FIG. 39A, uniform luminance and uniform outgoing angle distribution all over the surface of the liquid crystal panel can be obtained by reducing the transmittance of a diffusion plate 1, or increasing the thickness of the backlight to thereby increase the distance between each light source 4 and the diffusion plate 1. However, when the transmittance is reduced, the efficiency in extracting light from the backlight is reduced on a large scale so that the luminance decreases largely. When the distance between the light source 4 and the diffusion plate 1 is increased, the efficiency in extracting light from the backlight is reduced so that the luminance decreases and the thickness of the liquid crystal display apparatus increases. Thus, both the methods cannot be used.

In these circumstances, in order to increase the luminance of the backlight without increasing the luminance of each light source, it is effective to increase the transmittance of the diffusion plate 1 disposed between each light source 4 and a liquid crystal display device 3 and shorten the distance between the light source 4 and the diffusion plate 1 as shown in FIG. 39B.

The shortening of the distance between the light source 4 and the diffusion plate 1 is an effective means because it is also effective in making the backlight thinner. When the transmittance of the diffusion plate 1 is increased, the number of times with which light from the light source 4 is reflected between a reflector plate 8 and the diffusion plate 1 is reduced so that the reflection loss caused by the reflector plate 8 is-reduced and the luminance is enhanced.

In addition, it is understood from the comparison between the case where the distance between each light source 4 and the diffusion plate 1 is large as shown in FIG. 39A and the case where the distance between each light source 4 and the diffusion plate 1 is small as shown in FIG. 39B, the shortening of the distance between the light source 4 and the diffusion plate 1 leads to reduction in reflection loss on a case end portion side surface 50 so that the luminance is enhanced.

However, due to a vast difference between the surface luminance of the light source 4 and necessary luminance in the backlight surface, the following problems (1) to (3) occur when the transmittance of the diffusion plate 1 is increased and the distance between the light source 4 and the diffusion plate 1 is shortened in order to increase the luminance of the backlight.

(1) When the transmittance of the diffusion plate 1 is increased, direct light from each light source 4 is apt to pass the diffusion plate 1 and come into view. Thus, a sight of the light source occurs to degrade the display quality of the liquid crystal display apparatus conspicuously.

(2) When the distance between each light source 4 and the diffusion plate 1 is shortened as shown in FIG. 39B, the incoming angle distribution of light incident on the diffusion plate 1 has a large variation between one site (point A just above a light source) and another (point B between light sources) of the diffusion plate 1.

The reason of the variation will be described. FIG. 40 is a diagram showing an outgoing angle distribution of outgoing light in each incident angle on each diffusion plate whose overall transmittance is 50%, 60%, 70%, 80%. As shown in FIG. 40, the outgoing angle of outgoing light from the diffusion plate whose overall transmittance is 50% or lower than 60% is not affected by the incident angle of incident light. On the contrary, the outgoing angle distribution of outgoing light from the diffusion plate whose overall transmittance is 60% or higher is apt to be affected by the incident angle distribution of incident light. Particularly the outgoing angle distribution of outgoing light from the diffusion plate whose overall transmittance is 70% or higher has a great peak in the outgoing angle as large as the incident angle.

Accordingly, when the distance between the light source 4 and the diffusion plate 1 is shortened and the overall transmittance of the diffusion plate is made 60% or higher as shown in FIG. 39B, the outgoing angle distribution has a variation between one site and another of the diffusion plate. That is, even if design is made to prevent luminance unevenness from occurring in the front direction, luminance unevenness may occur when the liquid crystal display apparatus is viewed at some angle. Thus, the display quality of the liquid crystal display apparatus is lost conspicuously.

(3) The cold cathode tube is long from side to side. Thus, the luminance distribution cannot be controlled partially. Typically the positive side is brighter. Thus, the cold cathode thus causes occurrence of luminance unevenness in the left/right direction.

The present invention was developed to solve the foregoing problems. It is an object of the present invention to provide a thin-type liquid crystal display apparatus which can obtain a uniform luminance and a uniform outgoing angle distribution all over the liquid crystal panel surface without increasing the quantity of light from each light source.

In order to solve the foregoing problems, according to the present invention, as stated in Claims 1 to 3, or as shown in FIGS. 1-4 and 13-16, a liquid crystal display apparatus includes a plurality of light emission portions, a liquid crystal display device, and an optical sheet disposed between said liquid crystal display device and said light emission portions and on the light emission side of said light emission portions, wherein each of said light emission portions includes an optical guide having a light reflection surface and a light transmission surface formed where the light reflection surface is absent, and one or more light emitting devices integrated with said optical guide, and said light reflection surface is a scatter reflection surface, while an average angle between said light reflection surface and said light transmission surface ranges from 7° to 23°.

As for the optical sheet, typically, a diffusion plate, a prism sheet or a combination of the both can be used. However, the present invention is not limited to these.

As stated in Claim 4, or as shown in FIG. 18, height of said light sources in each of said light emission portions is made not larger than 20% of thickness of said light emission portion.

As stated in Claim 5, or as shown in FIG. 19, a relation S2×0.3<S1×N is established when S1 designates an area of said light transmission surface of each of said light emission portions, N designates the number of said light emission portions, S2 designates an effective display area of said liquid crystal display apparatus.

As stated in Claim 6, or as shown in FIG. 9, a ratio of a distance between said light transmission surface of each of said light emission portions and a diffusion plate to a size of said light emission portion is not lower than 0.5 and not higher than 3.0.

As stated in Claims 7 to 9, or as shown in FIGS. 20 to 31, said light reflection surface of each of said light emission portions is formed into a shape such as a quadrangular pyramid or a deformed quadrangular pyramid (a shape having a rectangular bottom surface whose aspect ratio is substantially the same as the aspect ratio of TV such as 4:3 or 16:9), a six-sided pyramid or a deformed six-sided pyramid (a shape having a bottom surface whose aspect ratio is substantially the same as the aspect ratio of TV such as 4:3 or 16:9), a rounded quadrangular pyramid or a rounded deformed quadrangular pyramid having a bottom surface whose edge lines and/or bottom corners are rounded, or a rounded six-sided pyramid or a rounded deformed six-sided pyramid having a bottom surface whose edge lines and/or bottom corners are rounded, while said light sources of said light emission portion are disposed near a central vertex of the shape of the light reflection surface, or said light reflection surface of the light emission portion is formed as a sphere or an elliptic sphere (a shape having a ratio of its major axis to its minor axis substantially the same as the aspect ratio of TV such as 4:3 or 16:9), or a part of the sphere or the elliptic sphere, and said light sources of said light emission portion are disposed near an optical axis of the sphere.

Further, the front shape of the light reflection surface of each of the light emission portions is formed into a square, a rectangle (whose aspect ratio is substantially the same as the aspect ratio of TV such as 4:3 or 16:9), a hexagon, or a deformed hexagon (whose aspect ratio is substantially the same as the aspect ratio of TV such as 4:3 or 16:9).

As stated in Claim 10, or as shown in FIG. 33, the light transmission surface of each of said light emission portions has a convex shape, and height of said convex shape is made not larger than 20% of thickness of said light emission portion.

As stated in Claim 11, in a region between said light transmission surface of each of said light emission portions and a light transmission surface of another light emission portion adjacent thereto, a scatter reflection plate 14 is formed on almost the same level as said light transmission surfaces of said light emission portions, in parallel to said light transmission surfaces and in a region where said light transmission surfaces are absent.

As stated in Claim 12, said light sources of each of said light emission portions are at least three light emitting devices comprised of three primary colors R, G and B, and said light emitting devices are disposed in at least three places in said light emission portion, so that a color tone can be controlled by controlling luminance of each of said light emitting devices.

As stated in Claim 13, or as shown in FIG. 35, when said light sources of each of said light emission portions are at least three light emitting devices comprised of three primary colors R, G and B, and said light emitting devices are disposed in at least three places in said light emission portion, a relation L2<SQRT(S1)×0.06 is established when S1 designates an area of said light transmission surface of said light emission portion, and L2 designates a distance between adjacent ones of said light emitting devices.

As stated in Claim 14, transmittance of said diffusion plate on an axis of each of said light emission portions is made lower than average transmittance of said diffusion plate as a whole, so that uniformity of light outgoing angle distribution is improved.

As stated in Claim 15, transmittance of said diffusion plate on an axis of each of said light emission portions is made higher than average transmittance of said diffusion plate as a whole, so that luminance is enhanced.

As stated in Claim 16, or as shown in FIG. 37, quantity of light emission from said light emission portions is controlled for each of said light emission portions individually in accordance with an image input into said liquid crystal display device.

As stated in Claim 17, or as shown in FIG. 38, quantity of light emission from said light emission portions is controlled for each of said light sources of each of said light emission portions individually in accordance with an output signal from a detection device disposed in or near said light emission portion or near said light transmission surface of said light emission portion.

As stated in Claim 18, or as shown in FIG. 38, quantity of light emission from said light emission portions is controlled for each of said light emission portions individually in accordance with an output signal from a detection device disposed in or near said light emission portion or near said light transmission surface of said light emission portion and an image input into said liquid crystal display device.

As stated in Claim 19, or as shown in FIG. 36, a plurality of light emission units each integrating a plurality of said light emission portions are disposed, and quantity of light emission is controlled for each of said light emission units individually in accordance with an image input into said liquid crystal display device.

Thus, according to the present invention, it is possible to provide a thin-type liquid crystal display apparatus superior in high luminance, outgoing angle distribution uniformity, luminance distribution uniformity, and luminance distribution controllability.

### BRIEF DESCRIPTION OF THE DRAWINGS

FIG. 1 shows a perspective view of a liquid crystal display apparatus according to a first embodiment of the present invention;

FIG. 2 shows a perspective view for explaining a light emission portion 7 in FIG. 1;

FIG. 3 shows a sectional view of the liquid crystal display apparatus in FIG. 1;

FIG. 4 shows a sectional view for explaining the light emission portion 7 in FIG. 1;

FIGS. 5A-5D are diagrams for explaining the sectional shape of the light emission portion;

FIG. 6 is a diagram for explaining problems when a light reflection surface 5 is formed into a mirror surface;

FIG. 7 is an explanatory view for explaining the propagation state of light in the light emission portion;

FIGS. 8A-8B are diagrams for explaining an area illuminated by the light emission portion in the liquid crystal display apparatus;

FIG. 9 is a diagram for explaining the relationship between a ratio of a distance between a light transmission surface of the light emission portion and a diffusion plate to the size of the light emission portion and a ratio of luminance in an end portion of the liquid crystal display apparatus to luminance in the center thereof;

FIG. 10 is a diagram for explaining an average angle;

FIGS. 11A-11B are diagrams for explaining the influence of the average angle;

FIG. 12 is an explanatory view for explaining problems when the average angle is large;

FIG. 13 is a diagram for explaining the relationship between the average angle and specific-direction luminance unevenness with the ratio of the distance between the light transmission plate and the diffusion plate to the size of the light emission portion being set at 1.5, using a diffusion plate whose overall transmittance is 50%.

FIG. 14 is a diagram for explaining the relationship between the average angle and specific-direction luminance unevenness with the ratio of the distance between the light transmission plate and the diffusion plate to the size of the light emission portion being set at 1.5, using a diffusion plate whose overall transmittance is 60%.

FIG. 15 is a diagram for explaining the relationship between the average angle and specific-direction luminance unevenness with the ratio of the distance between the light transmission plate and the diffusion plate to the size of the light emission portion being set at 1.5, using a diffusion plate whose overall transmittance is 70%.

FIG. 16 is a diagram for explaining the relationship between the average angle and specific-direction luminance unevenness with the ratio of the distance between the light transmission plate and the diffusion plate to the size of the light emission portion being set at 1.5, using a diffusion plate whose overall transmittance is 80%.

FIG. 17 is a diagram for explaining the light source height and the light emission portion thickness;

FIG. 18 is a diagram for explaining the relationship between the ratio of the light source height to the light emission portion thickness and the efficiency in extracting light from the light emission portion;

FIG. 19 is a diagram for explaining the relationship between the ratio S1×N/S2 and the luminance unevenness;

FIG. 20 is a plan view of the light emission portion formed into a square and having a light reflection surface formed into a circle;

FIG. 21 is a plan view of the light emission portion formed into a square and having a light reflection surface formed into a shape larger than the inscribed circle of the light emission portion;

FIG. 22 is a plan view of the light emission portion formed into a hexagon and having a light reflection surface formed into a circle;

FIG. 23 is a plan view of the light emission portion formed into a hexagon and having a light reflection surface formed into a shape larger than the inscribed circle of the light emission portion;

FIG. 24 is a plan view of the light emission portion formed into a rectangle and having a light reflection surface formed into an ellipse;

FIG. 25 is a plan view of the light emission portion formed into a rectangle and having a light reflection surface formed into a shape larger than the inscribed ellipse of the light emission portion;

FIG. 26 is a plan view of the light emission portion formed into a hexagon and having a light reflection surface formed into an ellipse;

FIG. 27 is a plan view of the light emission portion formed into a hexagon and having a light reflection surface formed into a shape larger than the inscribed ellipse of the light emission portion;

FIG. 28 is a plan view of the light emission portion formed into a square and having a light reflection surface formed into a quadrangular pyramid or a rounded quadrangular pyramid;

FIG. 29 is a plan view of the light emission portion formed into a rectangle and having a light reflection surface formed into a quadrangular pyramid or a rounded quadrangular pyramid;

FIG. 30 is a plan view of the light emission portion formed into a hexagon and having a light reflection surface formed into a six-sided pyramid or a rounded six-sided pyramid;

FIG. 31 is a plan view of the light emission portion formed into a deformed hexagon and having a light reflection surface formed into a six-sided pyramid or a rounded six-sided pyramid;

FIGS. 32A-32D are diagrams for explaining the layout of light emission portions;

FIG. 33 is a diagram for explaining the relationship between the shape of the light transmission surface and the efficiency in extracting light;

FIG. 34 is a diagram for explaining the effect of the reflection portion;

FIG. 35 is a diagram for explaining the relationship between a ratio L2/SQRT(S1) and a color shading value;

FIG. 36 is a perspective view of a liquid crystal display apparatus for explaining a second embodiment of the present invention;

FIG. 37 is a block diagram of the liquid crystal display apparatus for explaining the second embodiment of the present invention;

FIG. 38 is a block diagram of a liquid crystal display apparatus for explaining a third embodiment of the present invention;

FIGS. 39A-39B are diagrams for explaining problems when the distance between the diffusion plate and the light source is shortened; and

FIG. 40 is a diagram for explaining outgoing angle distribution for each incident angle on each diffusion plate.

### DETAILED DESCRIPTION OF PREFERRED EMBODIMENTS

Embodiments of the present invention will be described below with reference to the drawings.

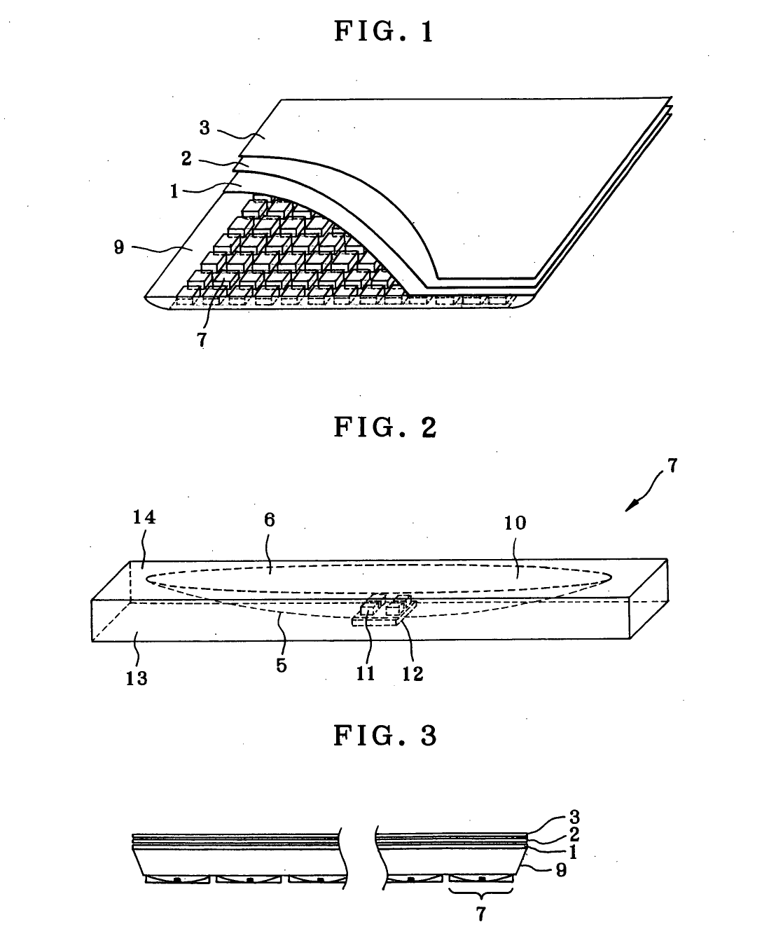

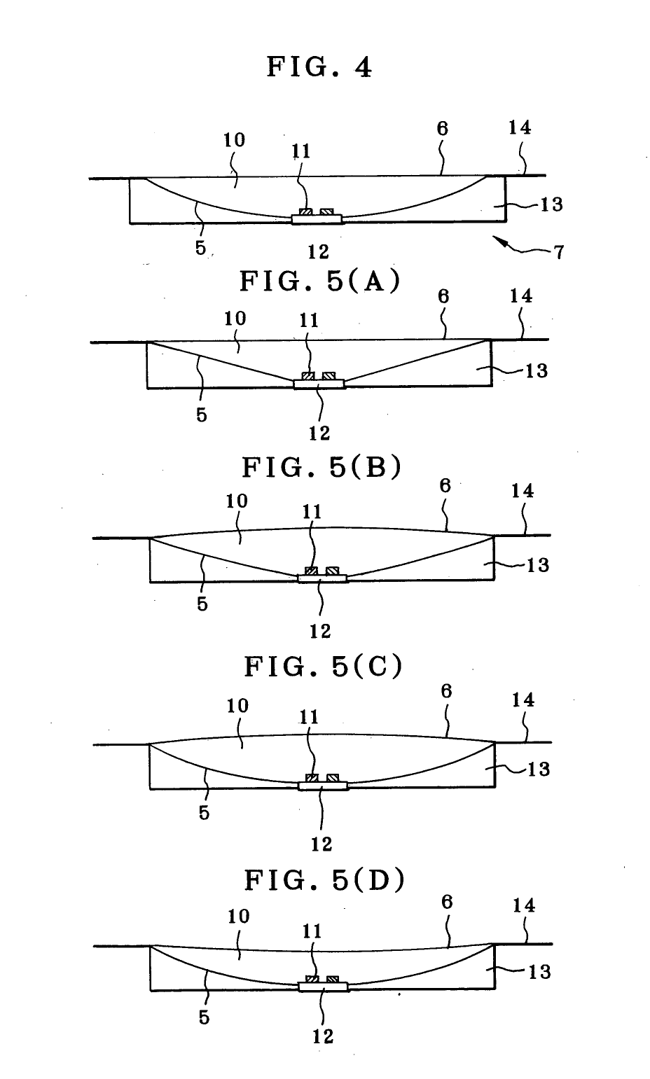

FIG. 1 is an overall explanatory view of a liquid crystal display apparatus according to a first embodiment of the present invention. FIG. 2 is a partial perspective view of a light emission portion including light sources in the liquid crystal display apparatus shown in FIG. 1. FIG. 3 is a sectional view of the liquid crystal display apparatus shown in FIG. 1. FIG. 4 is a sectional view of the light emission portion including light sources shown in FIG. 2.

In this embodiment, as shown in FIGS. 1 and 3, the liquid crystal display apparatus is constituted by a plurality of light emission portions 7, a liquid crystal display device 3, optical sheets 1 and 2, and a casing 9 supporting those members. The optical sheets 1 and 2 are disposed between the liquid crystal display device 3 and each light emission portion 7 and on the light emission side of the light emission portion 7. As the optical sheets, a diffusion plate 1, a prism sheet 2, a diffusible prism sheet, etc., are available.

A combination of at least one diffusion plate 1 and one or two prism sheets 2 is suitable. However, the optical sheets are not limited to this combination. In this embodiment, the optical sheets are composed of a diffusion plate 1 and a prism sheet 2.

As shown in FIGS. 2 and 4, each light emission portion 7 is constituted by an optical guide 10, one or more light emitting devices 11, an electrode 12, a substrate 13 and a reflection portion 14. The optical guide 10 has a light reflection surface 5 and a light transmission surface 6 formed where in any other surface than the light reflection surface 5. The light emitting devices 11 are integrated with the optical guide 10. Power is supplied to the light emitting devices 11 through the electrode 12. The substrate 13 supports the optical guide 10. The reflection portion 14 is formed in a surface substantially the same as the surface where the light transmission surface 6 is formed. Though not shown especially in FIGS. 2 and 4, the electrode 12 is divided into areas the number of which is sufficient to drive the light emitting devices 11.

The light emitting devices 11 are planted in the optical guide 10, and physically and optically coupled with the optical guide 10 by the optical guide 10 itself or resin having almost the same index of refraction as that of the optical guide 10. Consequently, light generated from the light emitting devices 11 can enter the optical guide 10 efficiently. The light reflection surface 5 and the light transmission surface 6 are disposed to face each other as shown in FIG. 4.

Various methods are conceivable as means for forming the light reflection surface 5. It is efficient to make the substrate 13 from white resin with high reflectivity, place the light emitting devices 11 thereon, and then pack them by molding out of transparent resin so as to form the light reflection surface 5 out of the surface of the substrate 13. However, the means for forming the light reflection surface 5 is not limited to this method.

As for the sectional shapes of the light reflection surface 5 and the light transmission surface 6, the light transmission surface 6 is made flat, and the light reflection surface is made concave, as shown in FIG. 4. Alternatively, as shown in FIGS. 5A-5D, a flat surface (FIGS. 5A-5B) or a concave shape (FIGS. 5C-5D) may be used as the light reflection surface 5, and a flat surface (FIG. 5A), a convex shape (FIGS. 5B-5C) or a concave shape (FIG. 5D) may be used as the light transmission surface.

Incidentally, in this embodiment, as shown in FIG. 2, four light emitting devices composed of three primary colors R, G and B are included in each light emission portion, and the light reflection surface 5 is spherical while the light transmission surface 6 is flat. However, the present invention is not limited to this configuration. The reason why the number of light emitting devices is not three is to increase the maximum luminance of the liquid crystal display apparatus by use of two light emitting devices for one color having the lowest efficiency of R, G and B because the light emitting devices differ in efficiency from one color of R, G and B to another.

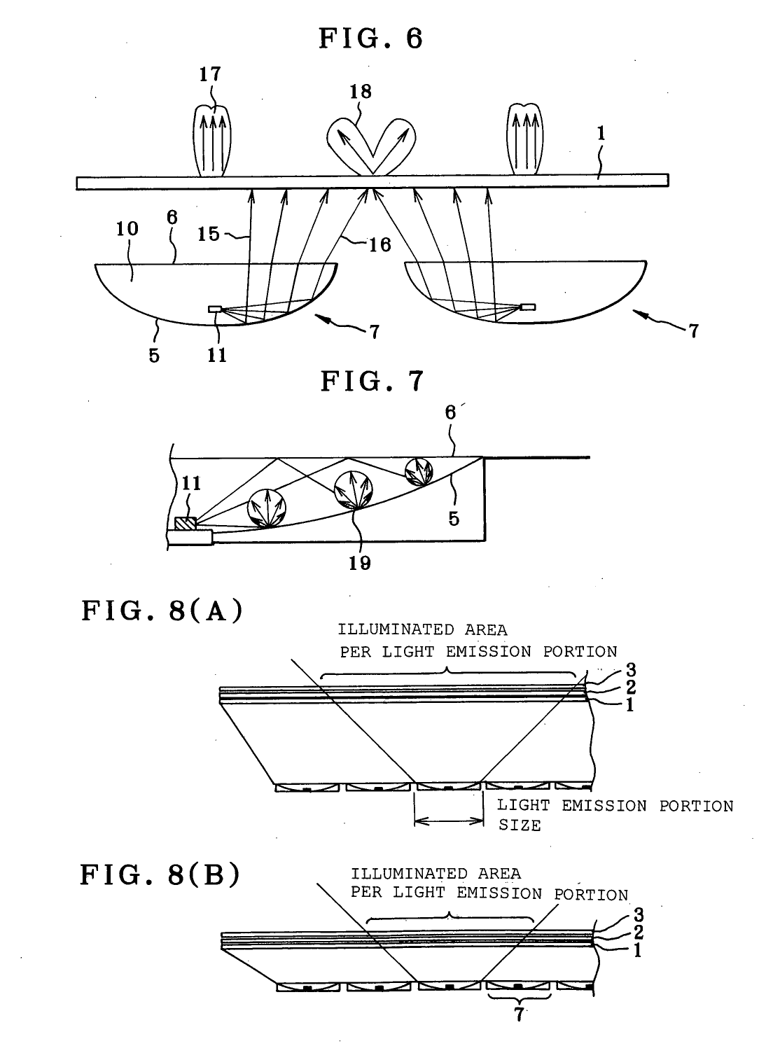

The light reflection surface 5 has to be a scatter reflection surface. This reason will be described below. If the light reflection surface 5 is formed as a mirror reflection surface as shown in FIG. 6, conspicuous directivity will occur in light outgoing from the light transmission surface 6. In this case, even if the shape of the light reflection surface 5 is designed appropriately so that the intensity distribution of light arriving at the diffusion plate 1 can be made uniform, between light 15 near each light emitting device and light 16 between adjacent light emitting devices, a conspicuous difference in incident angle distribution of the light 15, 16 with respect to the diffusion plate 1 will occur from place to place over the diffusion plate 1.

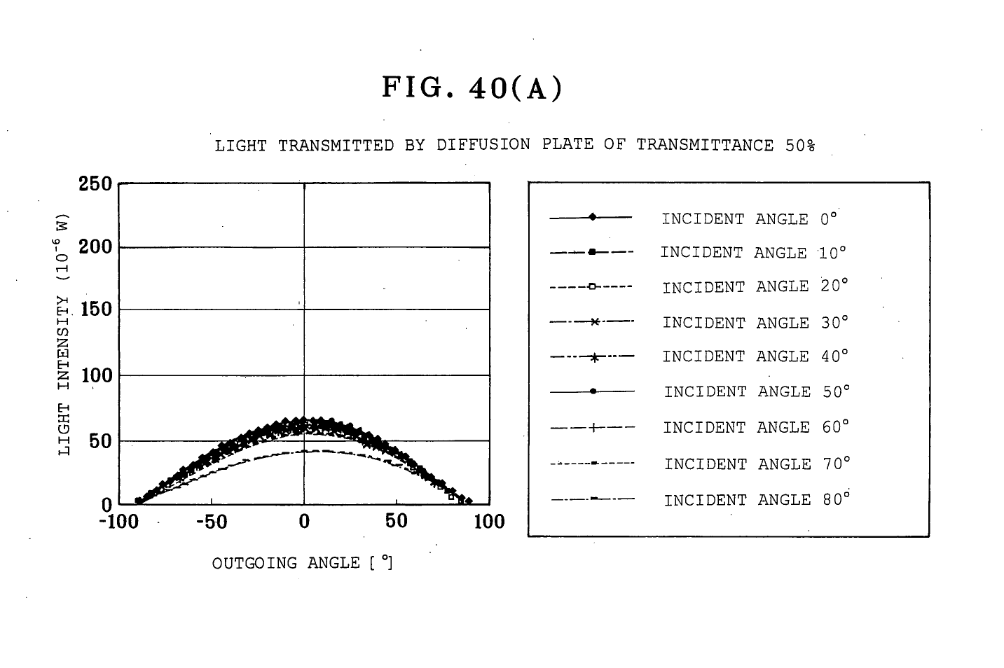

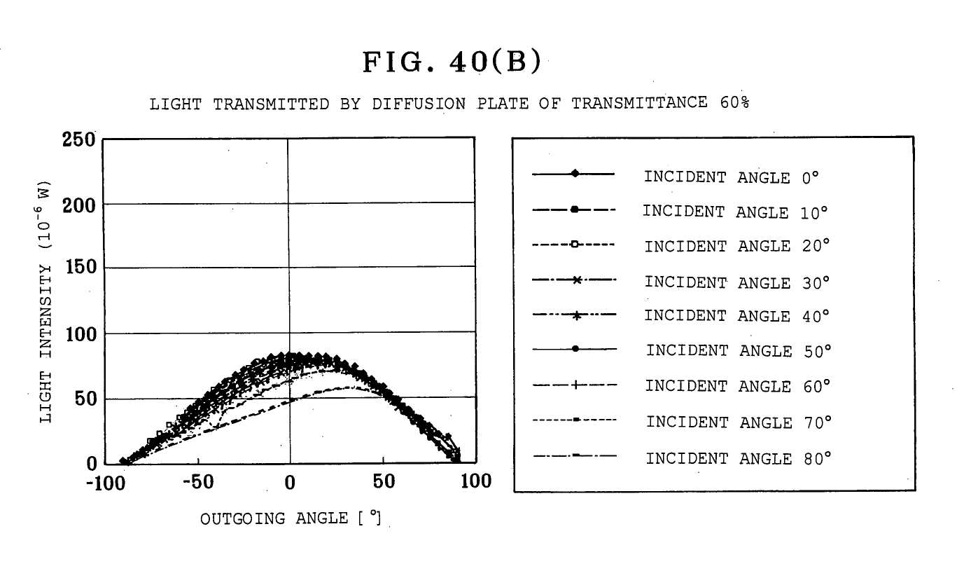

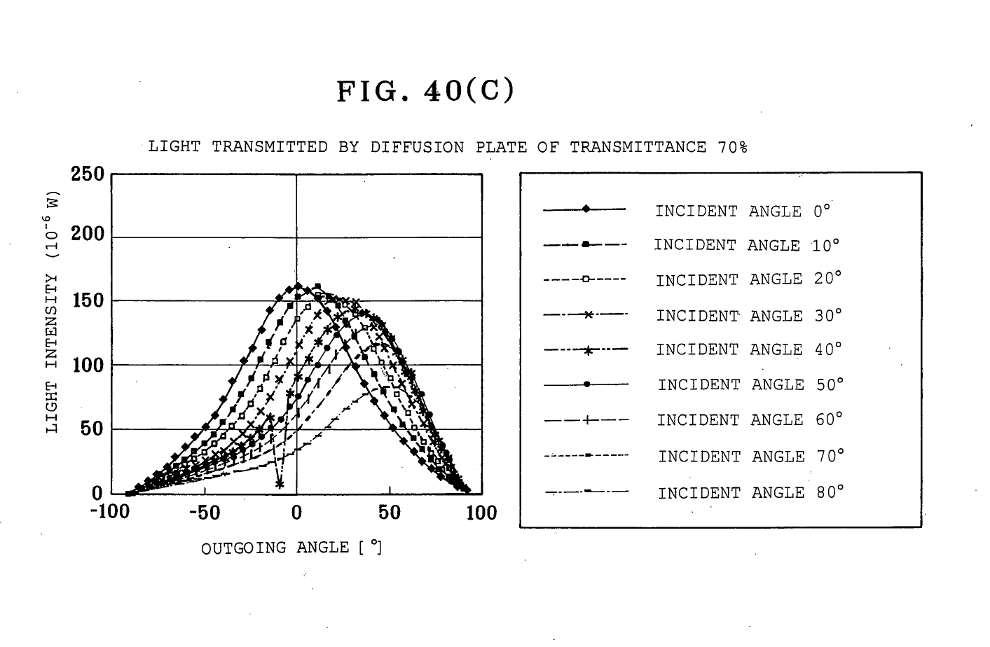

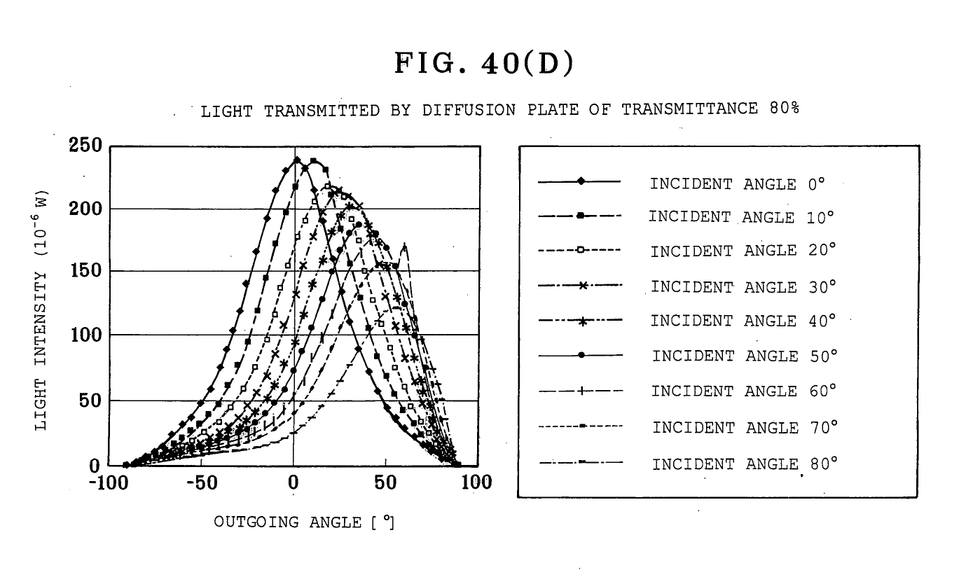

In this case, as is understood from FIG. 40, when the diffusion plate 1 whose overall transmittance is 60% or higher is used, for example, between outgoing light 17 near each light emitting device 11 and outgoing light 18 between adjacent light emitting devices 11, the outgoing angle distribution of the outgoing light 17, 18 from the diffusion plate 1 has a large variation due to the position relationship between the diffusion plate 1 and each light emitting portion 7.

As a result, the luminance distribution will be varied in accordance with the angle with which the liquid crystal display apparatus is viewed. Accordingly, even if the shape of the reflection surface is devised to prevent luminance unevenness from occurring when the liquid crystal display apparatus is observed square, luminance unevenness will occur when the liquid crystal display apparatus is observed obliquely. Thus, the image display quality will be degraded conspicuously.

In the following description, the phenomenon that there occurs luminance unevenness varied in distribution in accordance with the angle with which the liquid crystal display apparatus is viewed will be referred to as “luminance unevenness by outgoing angle”. In addition, luminance unevenness in a specific direction is varied in accordance with the angle with which the liquid crystal display apparatus is viewed. Accordingly, the luminance unevenness has to be evaluated by a plurality of outgoing angles.

When the overall transmittance of the diffusion plate is made extremely low, this problem can be prevented to some extent. However, in the diffusion plate whose overall transmittance is 60% or higher, the outgoing angle distribution of transmitted light has incident angle dependency as shown in FIG. 40. It is therefore extremely difficult to solve the foregoing problem.

On the other hand, reduction in overall transmittance leads to lowering of efficiency in extracting light from the backlight, causing lowering of the luminance of the backlight. Thus, the reduction in overall transmittance is not preferable.

Here, assume that the light reflection surface 5 is based on scatter reflection. In this case, as shown in FIG. 7, light from the light emitting device 11 undergoes reflection on the light transmission surface 6, and suffers scatter reflection 19 in the light reflection surface 5. Accordingly, light outgoing from the light transmission surface 6 becomes scattering light due to the scatter reflection. Thus, in the outgoing angle distribution of the light outgoing from the light transmission surface 6, the influence of the position of the light transmission surface 6 can be reduced overwhelmingly as compared with that in mirror reflection.

Consequently, the angle distribution of incident light over the diffusion plate 1 becomes substantially uniform in any position of the diffusion plate 1, so that the occurrence of luminance unevenness by outgoing angle can be reduced.

Next, the proper range of the distance between the light transmission surface 6 and the diffusion plate 1 will be described. When the distance between the light transmission surface 6 of the light emission portion 7 and the diffusion plate 1 is increased, luminance unevenness in a specific direction can be reduced, but it is unpleasantly difficult to make the liquid crystal display apparatus thinner.

In addition, when the distance between the light transmission surface 6 of the light emission portion 7 and the diffusion plate 1 is increased, an area illuminated by one light emission portion is increased as shown in FIG. 8A where the distance between the light transmission surface and the diffusion plate is large, as compared with the case where the distance between the light transmission surface and the diffusion plate is small as shown in FIG. 8B. In this case, when the quantity of light emitted by each light emission portion is controlled individually, it is unpleasantly difficult to control the quantity of light emitted by another light emission portion adjacent thereto, as will be described later.

Further, when the distance between the light transmission surface 6 of the light emission portion 7 and the diffusion plate 1 is increased, light is apt to be gathered in a central portion of the liquid crystal display apparatus. As a result, the luminance in an end portion of the liquid crystal display apparatus is lowered so that uniformity in luminance distribution is degraded unpleasantly.

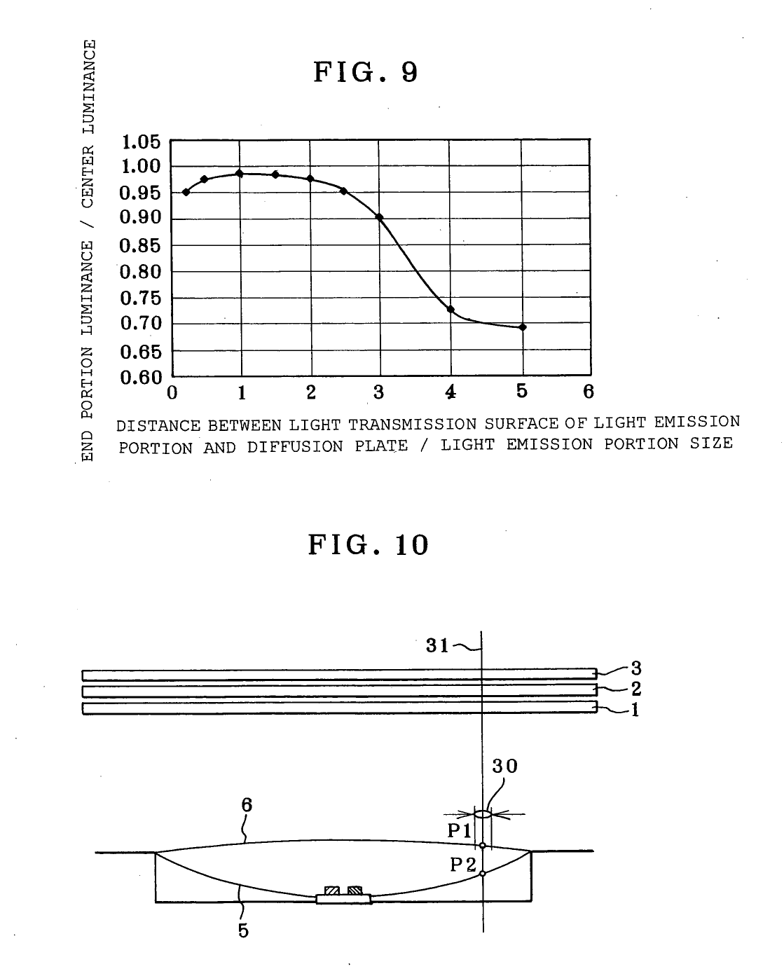

FIG. 9 shows the relationship between the ratio of the distance between the light transmission surface of the light emission portion to the size of the light emission portion and the ratio of the luminance in an end portion of the liquid crystal display apparatus to the luminance in the central portion thereof. When the ratio of the distance between the light transmission surface of the light emission portion to the size of the light emission portion is made not higher than 3.0 (preferably not higher than 2.0), the lowering of the luminance in the end portion can be suppressed. Incidentally, the size of the light emission portion is the size of the light transmission surface of the light emission portion (the diameter of the transmission surface when it is a circle, or an average diameter of a circumscribed circle and an inscribed circle of the transmission surface when it is a polygon).

When the lower limit of the distance between the light transmission surface of the light emission portion and the diffusion plate is too small, unevenness in light quantity over the light transmission surface will be influenced greatly. Accordingly, the distance should be made as large as possible within a range where the luminance of the liquid crystal display apparatus can be prevented from lowering in its end portion. Thus, it is desired that the ratio of the distance between the light transmission surface of the light emission portion to the size of the light emission portion is made not lower than 0.5 (preferably not lower than 1.0).

Next, description will be made about the relationship between the light transmission surface 6 and the light reflection surface 5. When the ratio of the distance between the light transmission surface of the light emission portion to the size of the light emission portion is made not lower than 0.5 and not higher than 3.0, the average angle between the light reflection surface 5 and the light transmission surface 6 in the light emission portion has to range from 7° to 25°. The average angle is calculated in the following method.

As shown in FIG. 10, the light transmission surface 6 is divided into very small blocks 30. Assume that P1 designates an intersection point between the light transmission surface 6 and a straight line 31 perpendicular to the liquid crystal display device 3 and passing a very small block 30, and θ1 designates an angle between a normal of the light transmission surface 6 at the intersection point P1 and the straight line 31 perpendicular to the liquid crystal display device 3 and passing the very small block 30.

In addition, assume that P2 designates an intersection point between the light reflection surface 5 and the straight line 31 perpendicular to the liquid crystal display device 3 and passing the very small block 30, and θ2 designates an angle between a normal of the light reflection surface 5 at the intersection point P2 and the straight line 31 perpendicular to the liquid crystal display device 3 and passing the very small block 30. Thus, the angles θ1 and θ2 are calculated. The average angle is a weighted average value of a differential value between the angles θ1 and θ2 taken all over the light transmission surface in consideration of the area of the very small section.

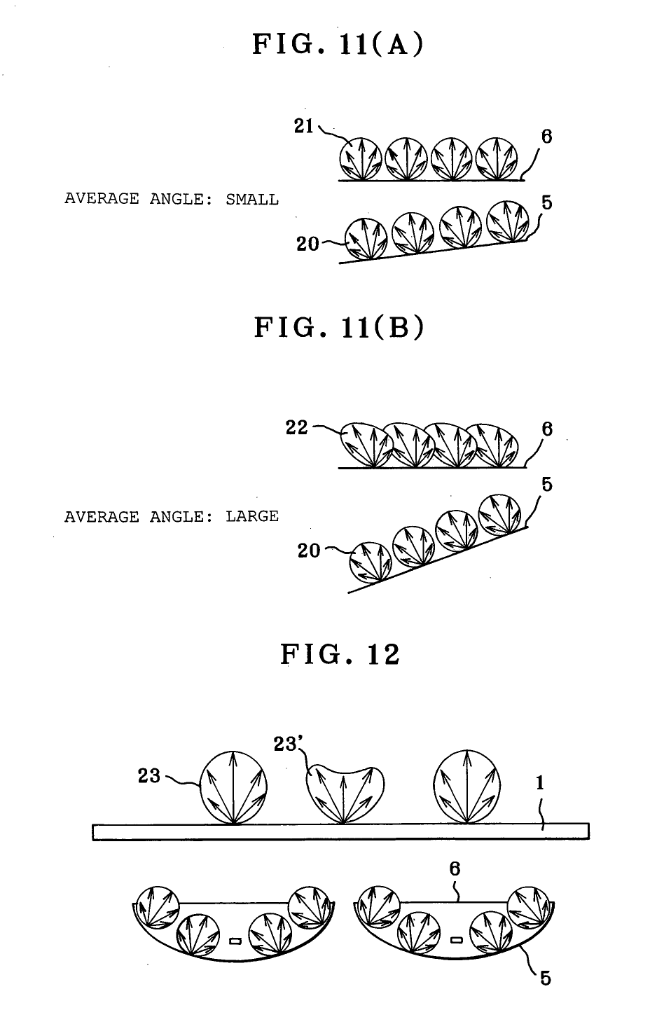

Here, the reason why the average angle is set in a range of from 7° to 23° will be described below. When the average angle is small, light 20 isotropically scattering in the light reflection surface 5 is formed into outgoing light 21 close to isotropically scattering light from the light transmission surface 6, as shown in FIG. 11A. On the contrary, when the average angle is large, the light 20 isotropically scattering in the light reflection surface 5 is formed into outgoing light 22 from the light transmission surface 6, the outgoing light 22 having a peak in a direction perpendicular to the light reflection surface 5, as shown in FIG. 11B.

Accordingly, when the average angle is large, there is a difference between the outgoing angle distribution of outgoing light 23 from the diffusion plate 1 near an optical axis of each light emission portion and the outgoing angle distribution of outgoing light 23′ from the diffusion plate 1 between optical axes of adjacent light emission portions, as shown in FIG. 12. Thus, luminance unevenness by outgoing angle occurs between the region near the, optical axis of each light emission portion and the region between the optical axes of adjacent light emission portions.

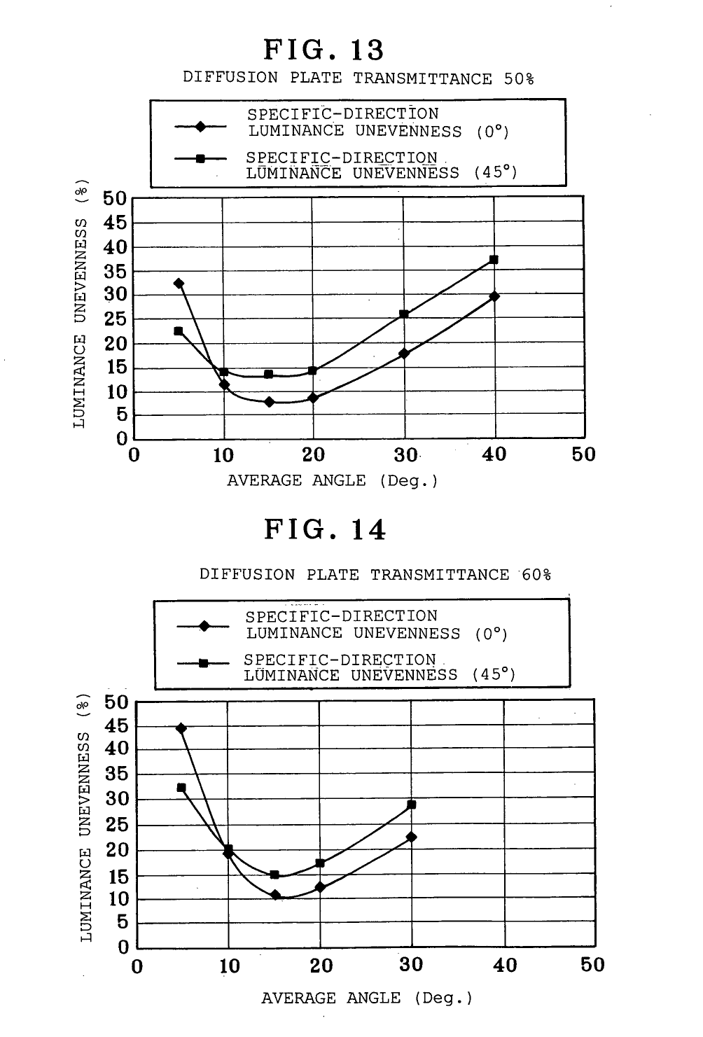

FIGS. 13-16 show results of evaluation of the relationship between the average angle and the state of occurrence of luminance unevenness in a specific direction when the shape of the reflection surface was optimized to keep the luminance unevenness in the specific direction to the minimum (aiming at luminance unevenness of 20% or lower) in the outgoing angle 0° with the ratio of the distance between the light transmission plate and the diffusion plate to the size of the light emission portion being set at 1.5, using diffusion plates whose overall transmittances were 50%, 60%, 70% and 80% respectively. Incidentally, the luminance unevenness is expressed by:
luminance unevenness=(maximum luminance−minimum luminance)÷average luminance

The outgoing angle used for evaluating the luminance unevenness in the specific direction was set at 45°. This is because the luminance unevenness with the outgoing angle up to about 45° has to be suppressed to be as low as that in square view when the liquid crystal display apparatus is used as a liquid crystal TV or a PC monitor.

The tolerance of luminance unevenness is 20% or lower. When the luminance unevenness was 20% or lower, the luminance unevenness was not observed as unevenness. That is, both the luminance unevenness in a specific direction (0°) and the luminance unevenness in a specific direction (45°) have to be 20% or lower.

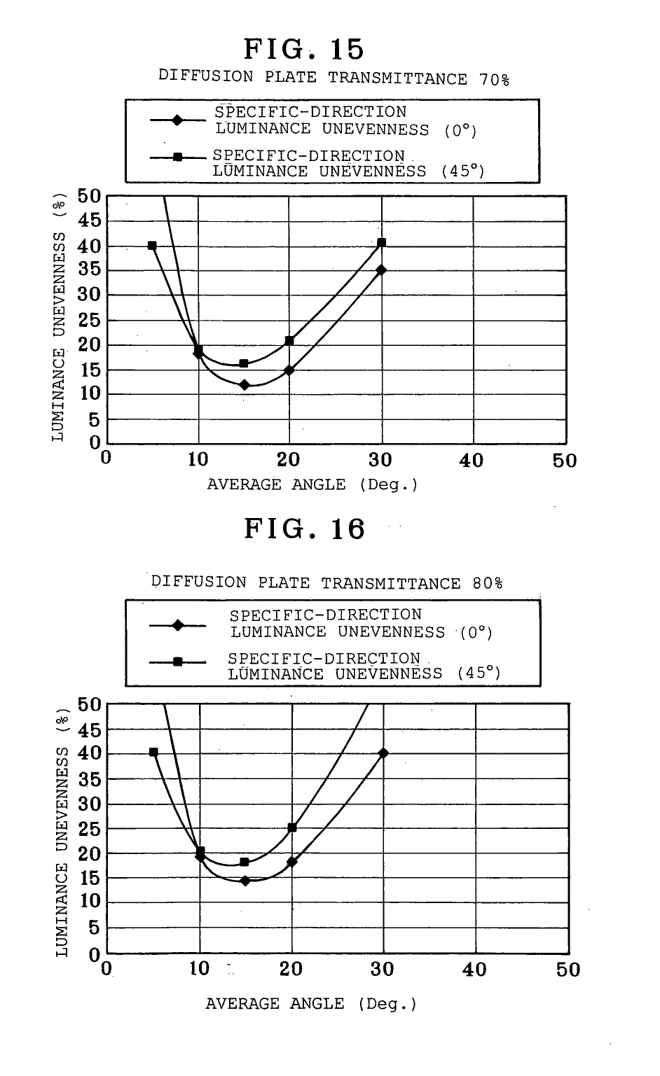

As above, it is preferable that the proper range of the average angle is 7-25° for a diffusion plate whose overall transmittance is 50% as shown in FIG. 13, 10-23° for a diffusion plate whose overall transmittance is 60% as shown in FIG. 14, 10-19° for a diffusion plate whose overall transmittance is 70% as shown in FIG. 15, and 10-18° for a diffusion plate whose overall transmittance is 80% as shown in FIG. 16.

As for the position of the light emitting device 11 in the light emission portion 7, it is desired that the height of the light emitting device 11 in the light emission portion 7 is made not higher than 20% of the thickness of the light emission portion 7.

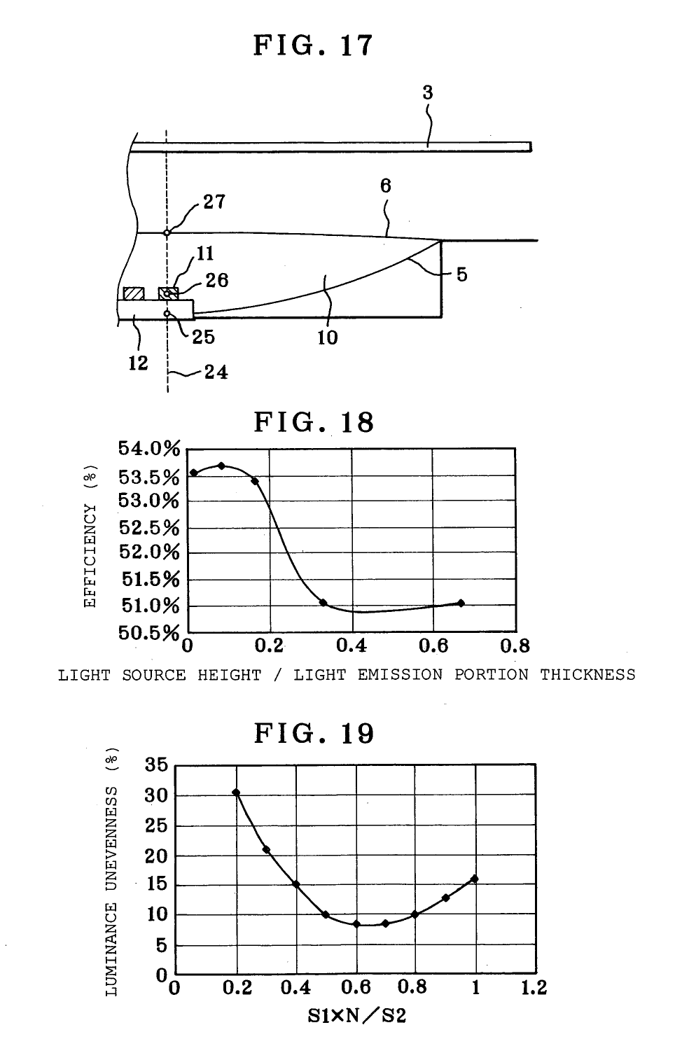

The height of-the light emitting device 11 corresponds to the distance between a point 25 and a point 26 as shown in FIG. 17. Incidentally, the point 25 is an intersection point of a straight line 24 perpendicular to the liquid crystal display device and passing the light emitting device 11 and the light reflection surface (in fact, a virtual reflection surface obtained by extending the light reflection surface because of the existence of the electrode 12). On the other hand, the point 26 is an intersection point of the light emitting device 11 and the straight line 24.

The thickness of the light emission portion 7 corresponds to the distance between the point 25 and a point 27 (an intersection point of the light transmission surface 6 and the straight line 24) as shown in FIG. 17. The reason why the position of the light emitting device 11 in the light emission portion 7 is assigned to the aforementioned range is to maximize the efficiency in extracting light from the light emitting device 11 serving as a light source.

FIG. 18 shows the relationship between the ratio of the light source height to the light emission portion thickness and the efficiency in extracting light from the light emission portion. The extracting efficiency can be enhanced by making the ratio of the light source height to the light emission portion thickness not higher than 0.2.

As for the ratio of the light transmission surface area S1 of each light emission portion 7 to the effective display area S2 of the liquid crystal display apparatus, it is desired that the relation S2×0.3<S1×N is established when N designates the number of light emission portions.

FIG. 19 shows the relationship between the ratio S1×N/S2 and the front luminance unevenness. When the ratio S1×N/S2 is set out of the aforementioned range, the front luminance unevenness is unpleasantly not lower than 20% of the visibility limit. This is because the light source serves as a point light source to thereby increase the influence of the position relationship between the light emission portion and the diffusion plate when S2×0.3>S1×N.

Incidentally, taking the specific-direction luminance unevenness into consideration, it is preferable that the front luminance unevenness is as low as possible. As shown in FIGS. 13-16, when it is taken into consideration that the specific-direction luminance unevenness (45°) is about 10% higher than the front luminance unevenness, it is more preferable that the relation S2×0.5<S1×N<S2×0.8 is established to make the front luminance unevenness not higher than 10%.

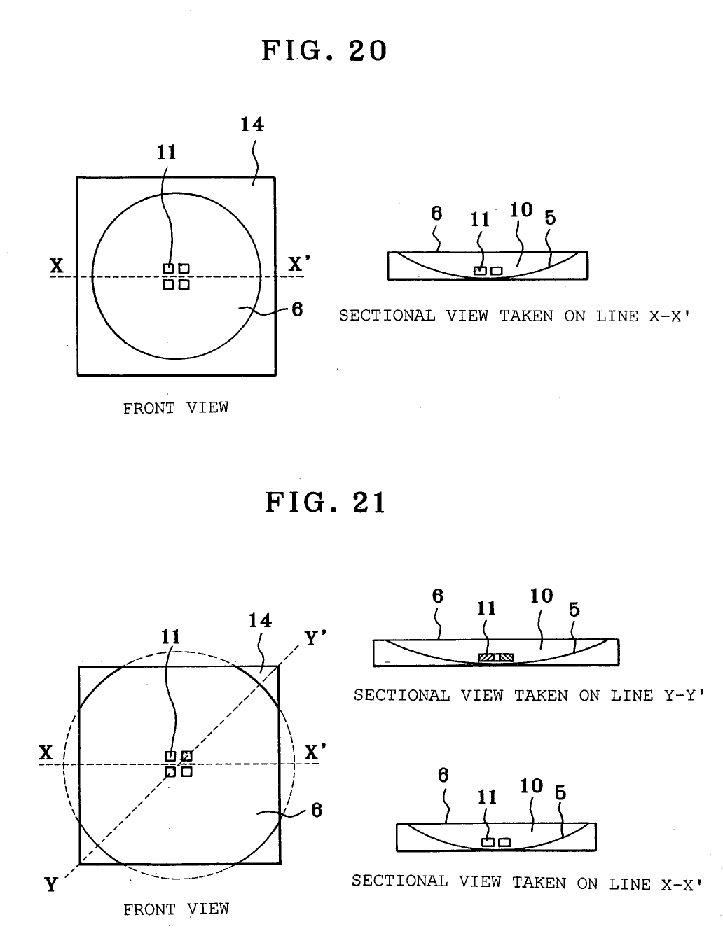

As for the position relationship between the cubic shape of the light reflection surface 5 and the light emitting devices 11 serving as light sources, it is desired that the light emitting devices 11 are disposed closely to the light reflection surface near the optical axis of a sphere partially composed of the light reflection surface 5, as shown in FIG. 20.

With such a layout, it is possible to reduce the anisotropy (difference between the outgoing angle distribution in the left/right direction and the outgoing angle distribution in the up/down direction) of the outgoing angle distribution of outgoing light from the light outgoing surfaces of the light emitting devices. Thus, the field angle characteristic of the liquid crystal display apparatus can be uniformized in all directions so that the visibility can be improved.

Alternatively, as shown in FIG. 21, the light reflection surface 5 may be made larger than the inscribed circle of the light emission portion. This shape can increase the ratio of the light transmission surface 6 to the effective display area of the liquid crystal display apparatus. Thus, there is an effect on reduction in front luminance or luminance unevenness.

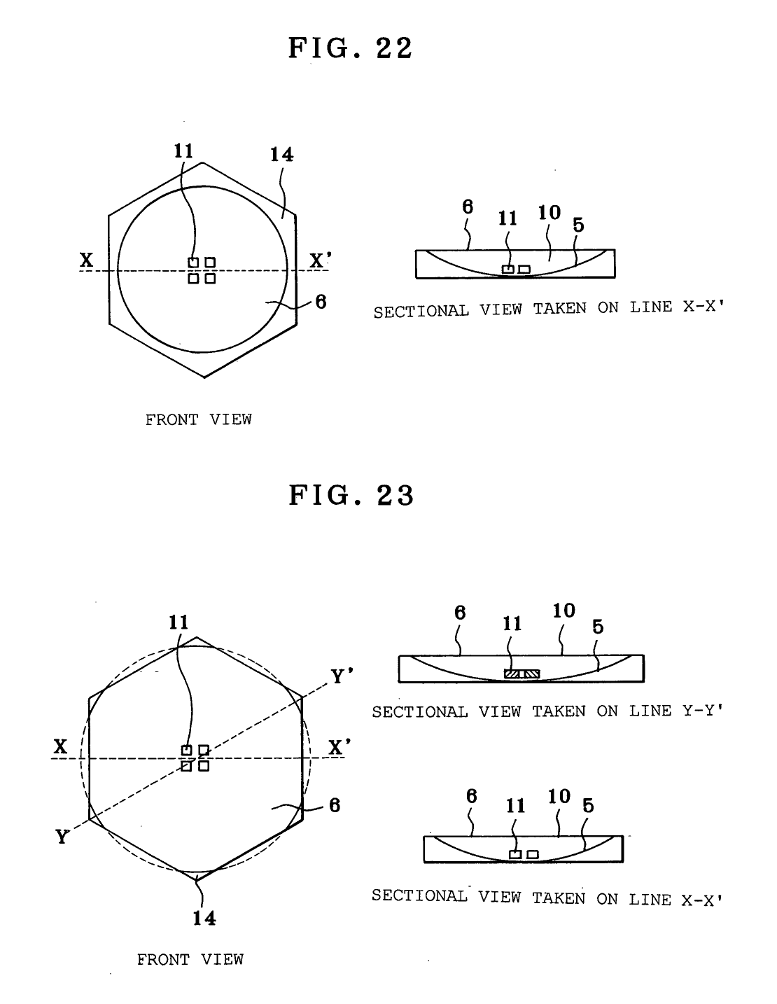

Alternatively, as shown in FIG. 22, the front shape of the light emission portion may be formed into a hexagon. In this case, the area of the light transmission surface 6 can be increased. Thus, front luminance or luminance unevenness is reduced as compared with that in the case of a square shape shown in FIG. 21.

Further, as shown in FIG. 23, the light reflection surface 5 may be made larger than the inscribed circle of the light emission portion. This shape can increase the ratio of the light transmission surface 6 to the effective display area of the liquid crystal display apparatus. Thus, there is an effect on reduction in front luminance or luminance unevenness.

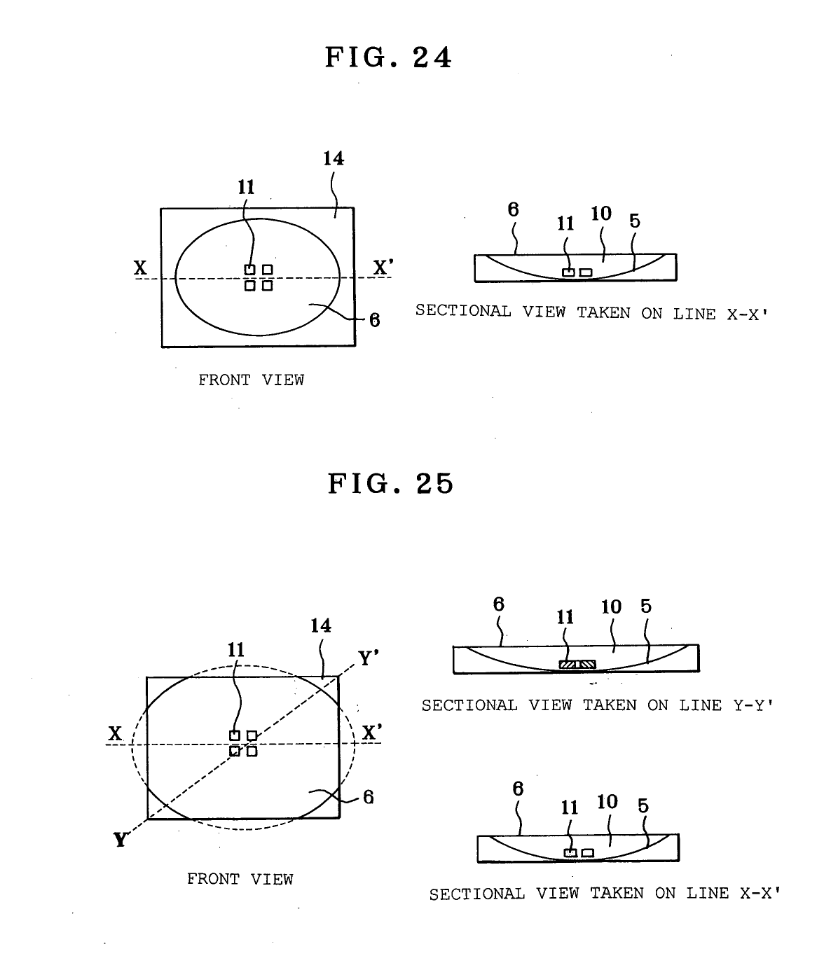

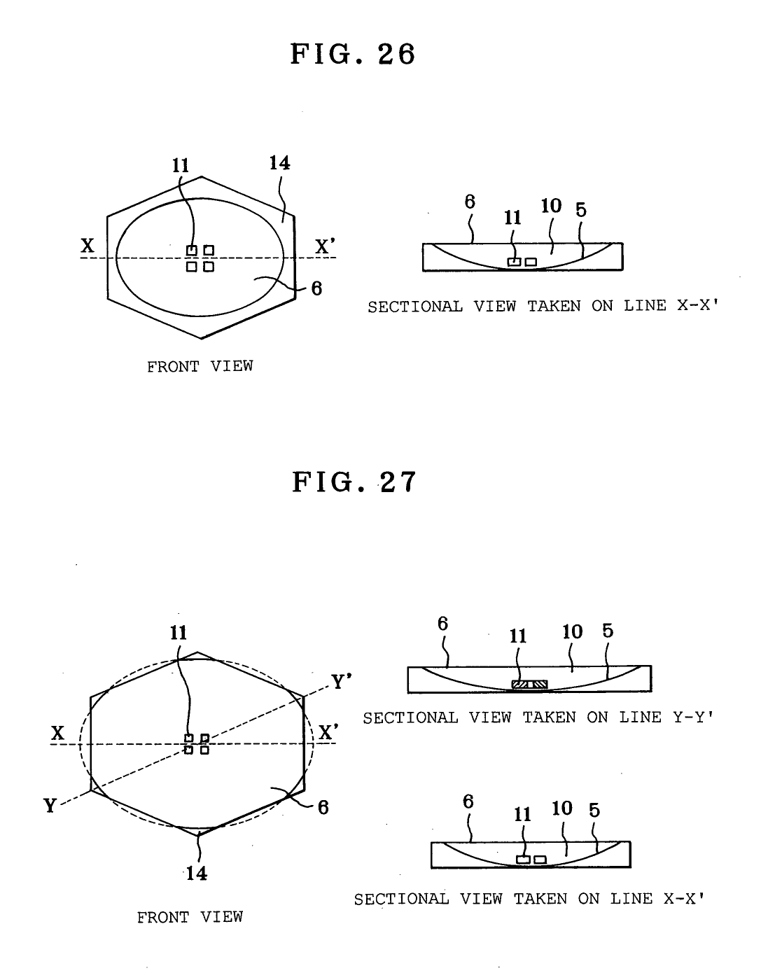

As other shapes than the aforementioned shapes, light sources may be disposed closely to the light reflection surface near the optical axis of an elliptic sphere (a shape having a ratio of its major axis to its minor axis substantially the same as the aspect ratio of TV such as 4:3 or 16:9, as shown in FIG. 24 or 26) composed of the light reflection surface 5 of the light emission portion 7 or partially composed thereof (as shown in FIG. 25 or 27) while the major axis direction is placed in parallel to the lateral direction of the screen, as shown in FIGS. 24-27.

With such a layout, it is possible to make the field angle in the up/down direction smaller than that in the left/right direction. Accordingly, the front luminance can be increased when the field angle in the up/down direction is not demanded in comparison with that in the left/right direction as in liquid crystal TV or the like.

Incidentally, in FIGS. 21-27, the light reflection surface 5 may be formed as a circular cone or a body of revolution of any curve. In comparison with a sphere, such a shape is difficult to design, but has an effect on uniformization of the luminance distribution.

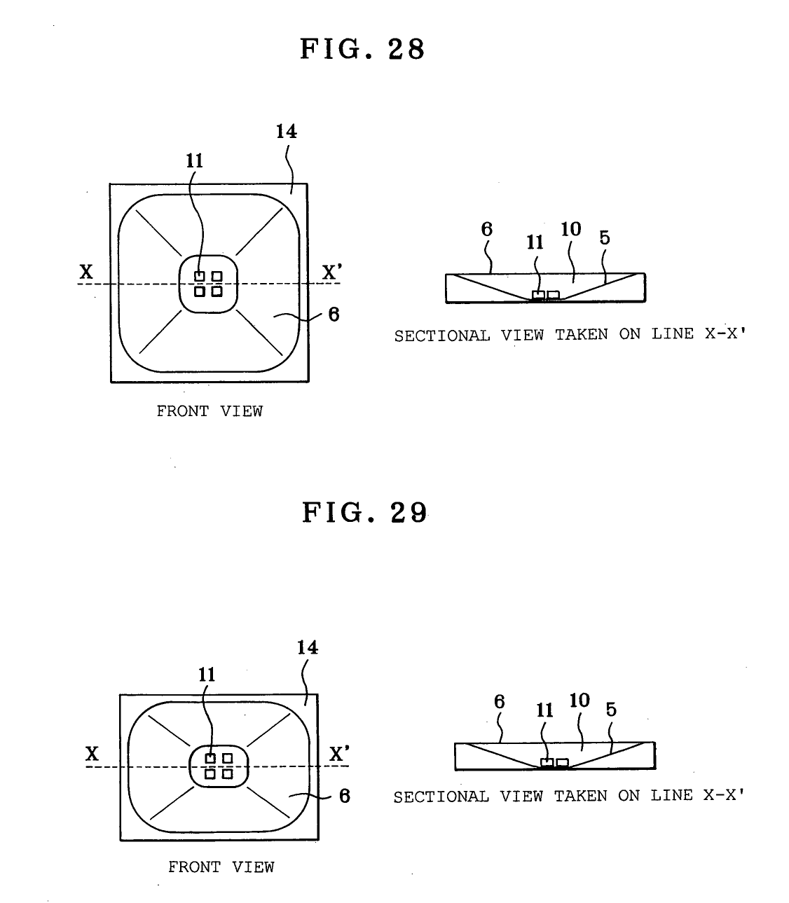

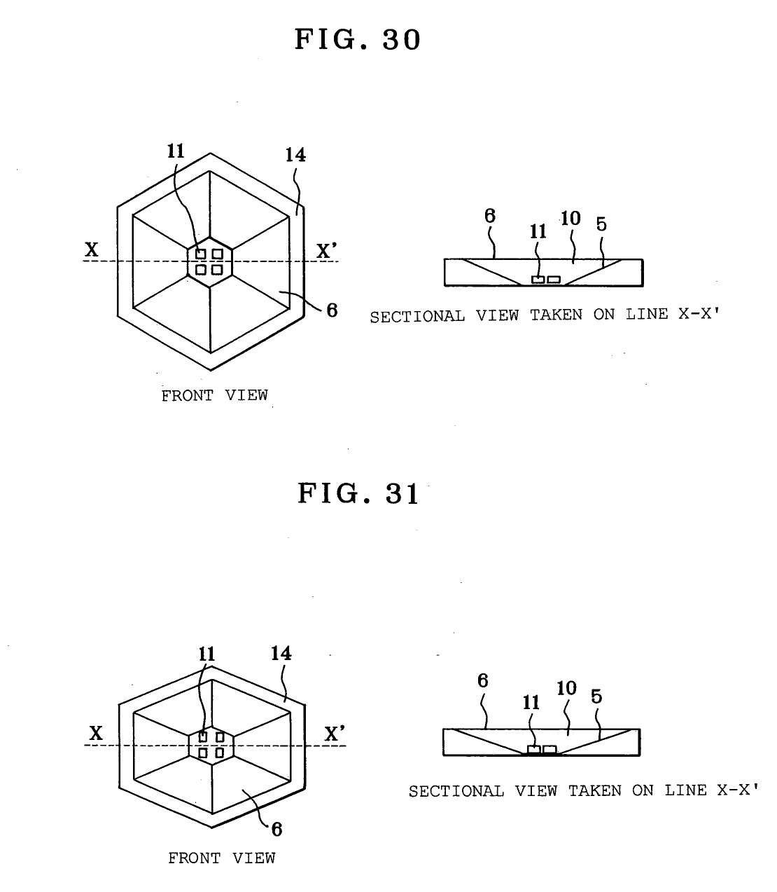

Alternatively, as shown in FIG. 28, the light reflection surface 5 may be formed as a quadrangular pyramid or a rounded quadrangular pyramid (having a shape in which edge lines and/or bottom corners of the quadrangular pyramid are rounded), while the light sources are disposed near the central vertex of the quadrangular pyramid. As a result, the ratio of the light transmission surface 6 to the effective display area of the liquid crystal display apparatus can be increased even when the front shape of the light emission portion is made quadrangular. Thus, there is an effect on reduction in front luminance or luminance unevenness.

Alternatively, as shown in FIG. 29, the ratio of the major axis to the minor axis may be made substantially the same as the aspect ratio of TV such as 4:3 or 16:9 while the major axis direction is placed in parallel to the lateral direction of the screen. With such a layout, it is possible to make the field angle in the up/down direction smaller than that in the left/right direction. Accordingly, the front luminance can be increased when the field angle in the up/down direction is not demanded in comparison with that in the left/right direction as in liquid crystal TV or the like.

Further, as other shapes than the aforementioned shapes, it is desired that the light reflection surface 5 is a six-sided pyramid or a rounded six-sided pyramid (having a shape in which edge lines and/or bottom corners of the six-sided pyramid are rounded), while the light sources are disposed near the central vertex of the six-sided pyramid. With such a layout, the anisotropy of the outgoing angle distribution of outgoing light from the light outgoing surfaces of the light emitting devices 11 can be reduced while the light emission surface area is increased.

Further, in accordance with necessity, the light emission portion may be shaped into a deformed hexagon (having an aspect ratio substantially the same as the aspect ratio of TV such as 4:3 or 16:9) as shown in FIG. 31.

By use of these shapes, the ratio of the light transmission surface area to the effective display area of the liquid crystal display apparatus can be increased. Thus, there is an effect on reduction in luminance unevenness.

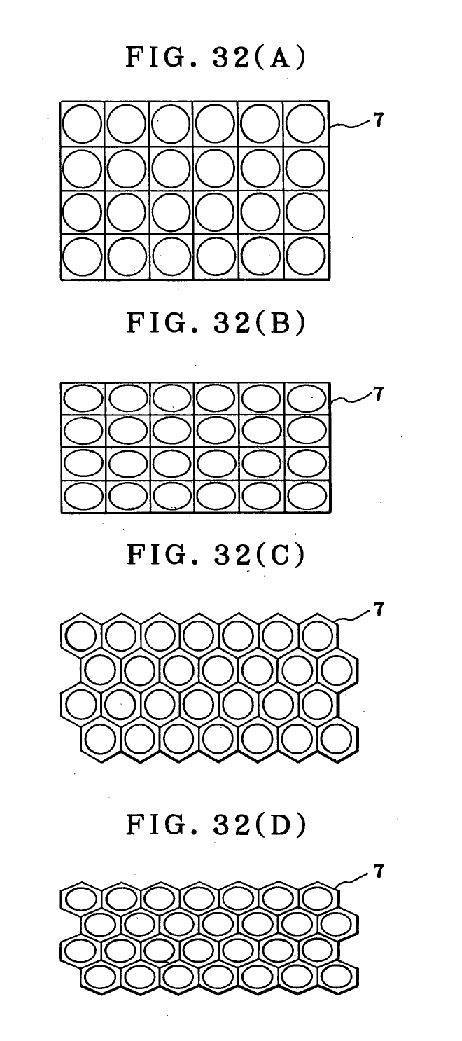

As for methods for arranging the light emission portions, rectangular arrangements (FIGS. 32A and 32B) or zigzag arrangements (FIGS. 32C and 32D) are available as shown in FIGS. 32A-32D. When the light emission portions are arranged, they should be arranged without leaving a large space therebetween. To this end, the rectangular arrangements are suitable when each light emission portion is square, and the zigzag arrangements are suitable when each light emission portion is hexagonal.

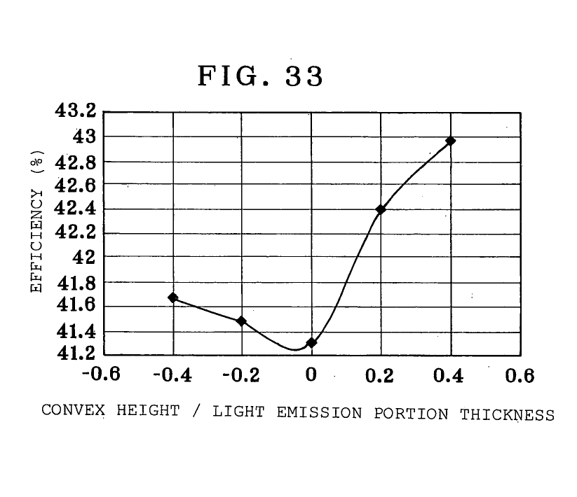

As for the sectional shape of the light transmission surface 6 of the light emission portion 7, a planar shape shown in FIG. 5A, convex shapes shown in FIGS. 5B and 5C, and a concave shape shown in FIG. 5D are available. However, from the point of view of the extracting efficiency, a convex shape (positive in the abscissa) is preferred to a concave shape (negative in the abscissa) or a planar shape (zero in the abscissa) as shown in FIG. 33. The efficiency is increased as the height of the convex portion is increased. However, when the height of the convex portion is made not lower than 20% of the thickness of the light emission portion, the average angle is increased unpleasantly.

In a region (corresponding to the reflection portion 14 shown in FIG. 4) between the light transmission surface of each light emission portion and the light transmission surface of another light emission portion adjacent thereto, it is desired to form a scatter reflection plate substantially on the same level as the light transmission surfaces, in parallel to the light transmission surfaces and in a region where the light transmission surfaces are absent.

That is, as the reflection portion 14 in FIG. 4, which is a region between the light transmission surface of each light emission portion and the light transmission surface of another light emission portion adjacent thereto, a scatter reflection plate is formed substantially on the same level as the light transmission surfaces, in parallel to the light transmission surfaces and in a region where the light transmission surfaces are absent.

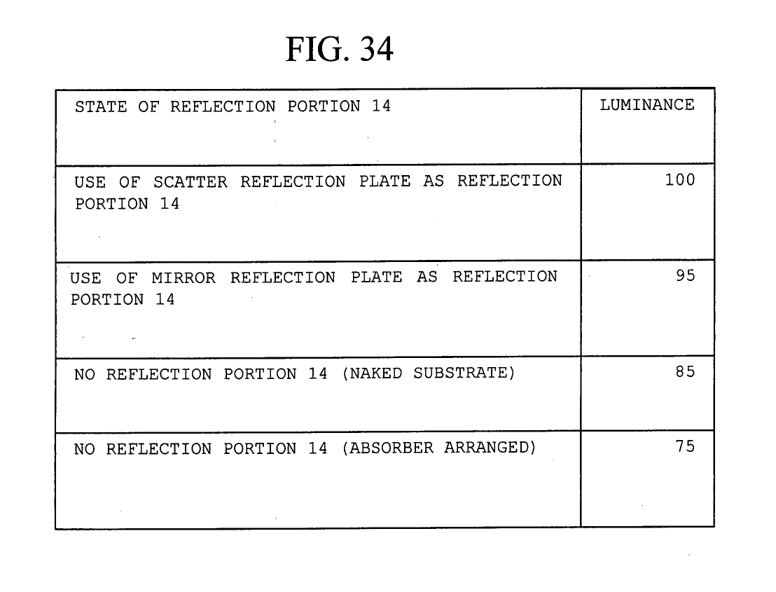

FIG. 34 shows results of comparison in luminance among the cases where the reflection portion 14 was formed and the cases where no reflection portion 14 was formed. When the reflection portion 14 is thus formed as scatter reflection, light reflected by the diffusion plate 1 can be returned to the diffusion plate efficiently. Thus, the luminance of the liquid crystal display apparatus can be increased.

As light sources of each light emission portion, it is desired that at least three light emitting devices comprised of the three primary colors R, G and B are disposed in at least three places in the light emission portion, and the color tone is controlled by controlling luminance of each of the light emitting devices. In this manner, the variation in chromaticity among the light emitting devices can be corrected for each light emission portion. Thus, it is possible to obtain a liquid crystal display apparatus having a uniform chromaticity characteristic.

Assume that the light emitting devices are at least three light emitting devices comprised of the three primary colors R, G and B, and disposed in at least three places of each light emission portion. In this case, it is desired that the distance between adjacent ones of the light emitting devices is defined as L2<SQRT(S1)×0.06 when S1 designates the area of the light transmission surface 6 of the light emission portion 7 and L2 designates the distance between the light emitting devices.

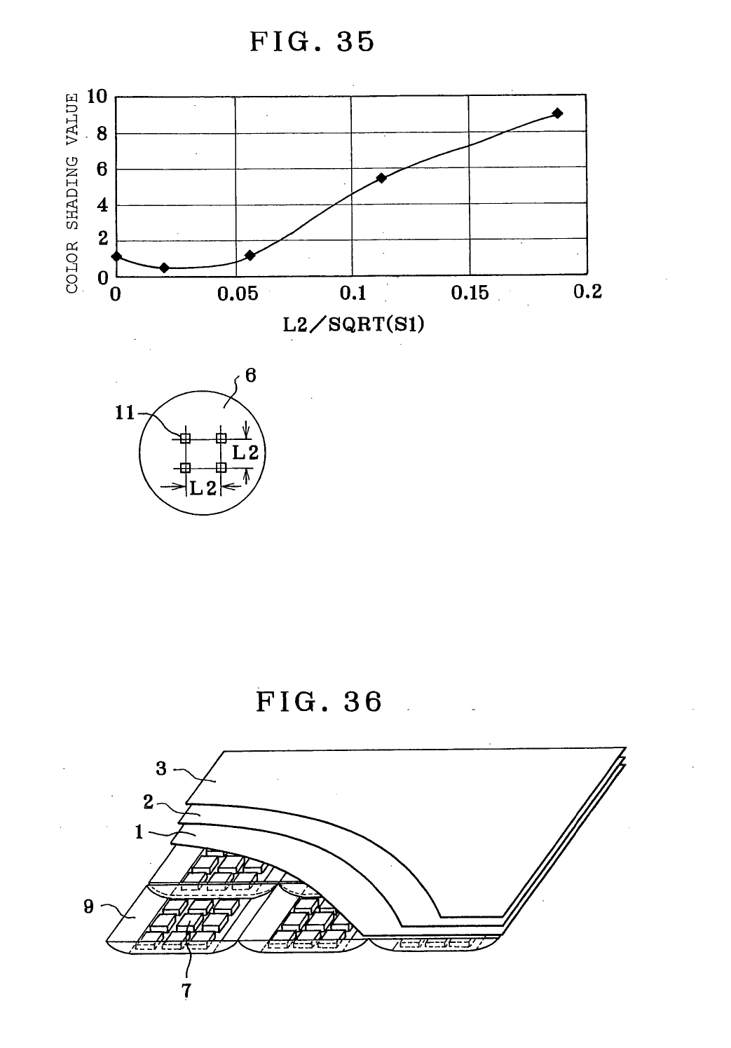

FIG. 35 shows a result of measurement as to the relationship between the ratio L2/SQRT(S1) and the color shading. The value of the color shading in FIG. 35 is obtained by:
color shading value=((highest luminance of R luminance, G luminance and B luminance)−(lowest luminance of R luminance, G luminance and B luminance))/(average luminance of R luminance, G luminance and B luminance)

As a result of visual examination, the color shading could not be seen when the color shading value was not larger than 2. Thus, the aforementioned range is proper. On the other hand, as for the lower limit, the color shading value, far from decreasing, increases due to the influence of reflection on the surfaces of the light emitting devices when the distance L2 is made too small. In addition, there also occur problems in mounting, heat release, etc. Thus, the proper range has a lower limit at 0.02 where the color shading value is minimized.

When the transmittance of the light diffusion plate on the optical axis of the light emission portion is made lower than the average transmittance of the light diffusion as a whole, there is an effect on improving the uniformity of the outgoing angle distribution. This reason will be described. An excellent symmetric property of the outgoing angle distribution of light from the light emitting devices can be obtained on each of optical axes of light emission portions. On the other hand, the symmetric property is inferior between adjacent ones of the optical axes, causing lowering of visibility. Therefore, when the transmittance of the diffusion plate in the portion where the symmetric property is excellent is reduced, the poorness of the symmetric property can be compensated relatively.

When the transmittance of the light diffusion plate on the optical axis of each light emission portion is made higher than the average transmittance of the light diffusion as a whole, there is an effect on improving the luminance. This is because the symmetric property of the outgoing angle distribution of light from the light emitting devices is excellent on each of the optical axes of the light emission portions so that the transmittance of the diffusion plate can be enhanced.

### Second Embodiment

FIG. 36 is a perspective view of a liquid crystal display apparatus according to a second embodiment of the present invention. In the liquid crystal display apparatus according to the present invention, a diffusion plate 1 is illuminated directly by light emission portions 7. Thus, the quantity of light emission from each light emission portion 7 can be controlled individually in accordance with an image input into a liquid crystal display device 3. As a result, the luminance of a backlight in a dark region on the screen can be cut down so that the power consumption can be saved.

In addition, when the luminance of the backlight in the dark region on the screen is cut down, leakage light from the liquid crystal display device can be reduced. Thus, there is an effect that the contrast can be enhanced.

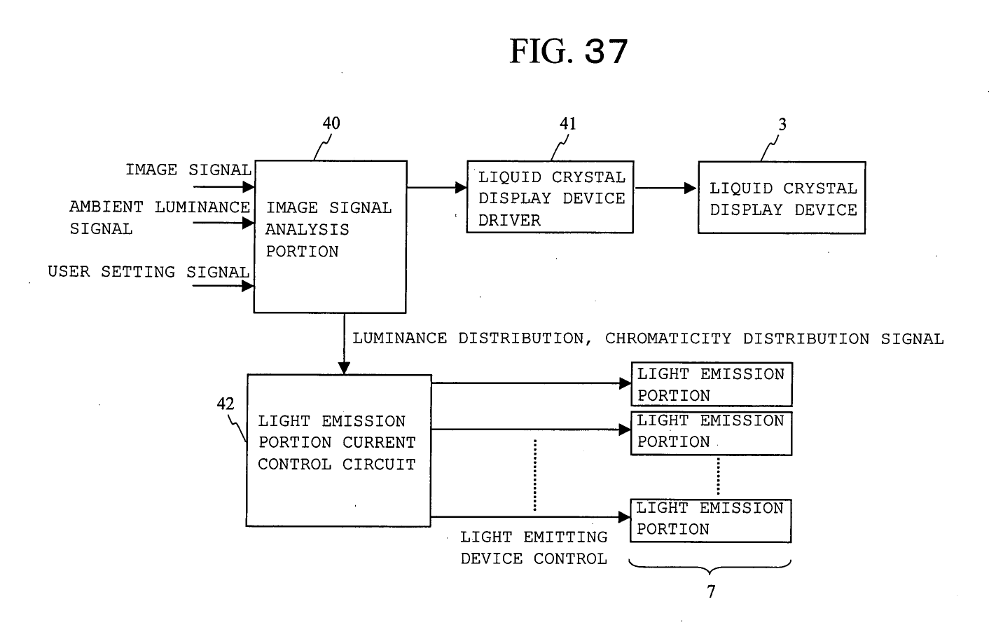

FIG. 37 is a block diagram of this embodiment. An image signal, an ambient luminance signal from an external sensor and a user setting signal from a remote controller or the like are input into an image signal analysis portion 40. The image signal analyzed on the basis of these signals is supplied to a liquid crystal device driver 41 and displayed by the liquid crystal device 3.

In addition, a luminance distribution signal and/or a chromaticity distribution signal as the image signal analyzed by the image signal analysis portion 40 are supplied to a light emission portion current control circuit 42 so as to control luminance and/or chromaticity of each light emission portion 7.

Here, for example, in FIG. 36, the quantity of light emission is controlled for each set of nine light emission portions 7 arranged three by three. However, the present invention is not limited to this manner. Each set may be arranged four by four or more by more, or all the light emission portions may be controlled individually or for each control unit of light emission portions arranged two by two or four by four. When a plurality of light emission portions 7 are unitized in such a manner, it is possible to simplify the image signal analysis portion 40 or the light emission portion current control circuit 42 or make their installation more efficient.

Incidentally, a driving current to each RGB light emitting device serving as a light source may be controlled to fit the hue, the color temperature, etc. to user's taste. In addition, luminance and/or chromaticity of each light emission portion can be adjusted to the ambient luminance in accordance with an input image signal so that the power consumption can be further saved.

### Third Embodiment

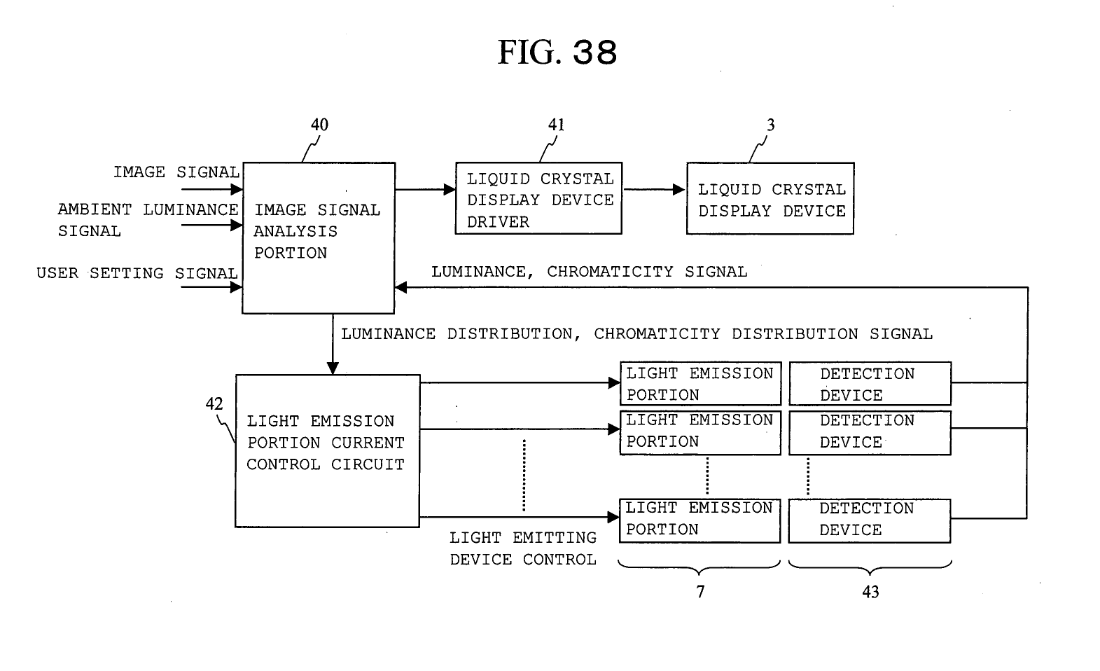

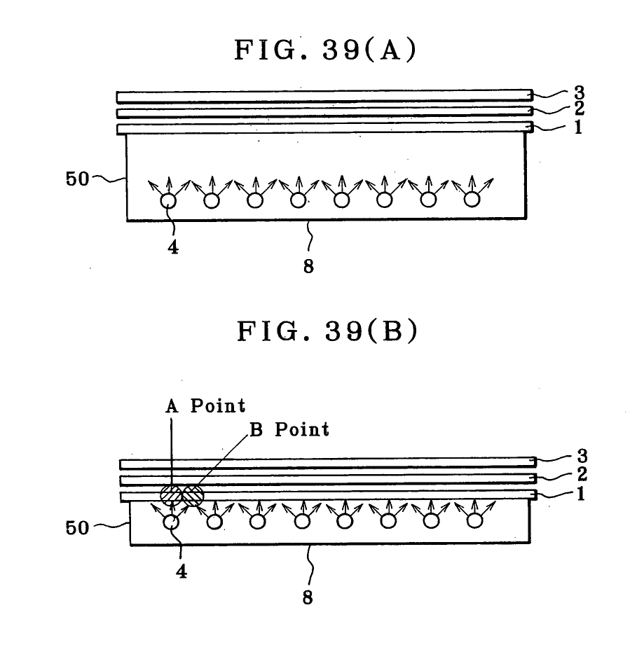

FIG. 38 is a block diagram of a third embodiment of the present invention. In this embodiment, in addition to the second embodiment shown in FIG. 37, the image signal analysis portion 40 controls the quantity of light emission from each light emitting device serving as a light source of each light emission portion 7 individually in accordance with an output signal from a detection device 43 disposed in or near the light emission portion or near the light transmission surface of the light emission portion.

1. A liquid crystal display apparatus comprising:
a plurality of light emission portions; and
a liquid crystal display device;
wherein each of said light emission portions includes an optical guide having a light reflection surface and a light transmission surface, and one or more light sources integrated with said optical guide, and said light reflection surface is a scatter reflection surface.

2. A liquid crystal display apparatus according to claim 1, further comprising:
an optical sheet disposed between said liquid crystal display device and said light emission portions and on the light emission side of said light emission portions.

3. A liquid crystal display apparatus according to claim 1, wherein an average angle between said light reflection surface and said light transmission surface ranges from 7° to 23°.

4. A liquid crystal display apparatus according to claim 1, wherein height of said light sources in each of said light emission portions is not larger than 20% of thickness of said light emission portion.

5. A liquid crystal display apparatus according to claim 1, wherein a relation S2×0.3<S1×N is established when S1 designates an area of said light transmission surface of each of said light emission portions, N designates the number of said light emission portions, S2 designates an effective display area of said liquid crystal display apparatus.

6. A liquid crystal display apparatus according to claim 1, wherein a ratio of a distance between said light transmission surface of each of said light emission portions and a diffusion plate to a size of said light emission portion is not lower than 0.5 and not higher than 3.0.

7. A liquid crystal display apparatus according to claim 1, wherein said light reflection surface of each of said light emission portions is a quadrangular pyramid or a rounded quadrangular pyramid, and said light sources of said light emission portion are disposed near a central vertex of said quadrangular pyramid.

8. A liquid crystal display apparatus according to claim 1, wherein said light reflection surface of each of said light emission portions is a six-sided pyramid or a rounded six-sided pyramid, and said light sources of said light emission portion are disposed near a central vertex of said six-sided pyramid.

9. A liquid crystal display apparatus according to claim 1, wherein said light reflection surface of each of said light emission portions is a part of a sphere, and said light sources of said light emission portion are disposed near an optical axis of said light reflection surface.

10. A liquid crystal display apparatus according to claim 1, wherein said light transmission surface of each of said light emission portions has a convex shape, and height of said convex shape is not larger than 20% of thickness of said light emission portion.

11. A liquid crystal display apparatus according to claim 1, wherein in a region between said light transmission surface of each of said light emission portions and a light transmission surface of another light emission portion adjacent thereto, a scatter reflection plate is formed on almost the same level as said light transmission surfaces of said light emission portions, in parallel to said light transmission surfaces and in a region where said light transmission surfaces are absent.

12. A liquid crystal display apparatus according to claim 1, wherein said light sources of each of said light emission portions are at least three light emitting devices comprised of three primary colors R, G and B, said light emitting devices are disposed in at least three places in said light emission portion, and a color tone is controlled by controlling luminance of each of said light emitting devices.

13. A liquid crystal display apparatus according to claim 1, wherein said light sources of each of said light emission portions are at least three light emitting devices comprised of three primary colors R, G and B, said light emitting devices are disposed in at least three places in said light emission portion, and a relation L2<SQRT(S1)×0.06 is established when S1 designates an area of said light transmission surface of said light emission portion, and L2 designates a distance between adjacent ones of said light emitting devices.

14. A liquid crystal display apparatus according to claim 1, wherein a diffusion plate is disposed between said liquid crystal display device and said light emission portions, transmittance of said diffusion plate on an axis of each of said light emission portions is made lower than average transmittance of said diffusion plate as a whole, so that uniformity of light outgoing angle distribution is improved.

15. A liquid crystal display apparatus according to claim 1, wherein a diffusion plate is disposed between said liquid crystal display device and said light emission portions, transmittance of said diffusion plate on an axis of each of said light emission portions is made higher than average transmittance of said diffusion plate as a whole, so that luminance is enhanced.

16. A liquid crystal display apparatus according to claim 1, wherein quantity of light emission from said light emission portions is controlled for each of said light emission portions individually in accordance with an image input into said liquid crystal display device.

17. A liquid crystal display apparatus according to claim 1, wherein quantity of light emission from said light emission portions is controlled for each of said light sources of each of said light emission portions individually in accordance with an output signal from a detection device disposed in or near said light emission portion or near said light transmission surface of said light emission portion.

18. A liquid crystal display apparatus according to claim 1, wherein quantity of light emission from said light emission portions is controlled for each of said light emission portions individually in accordance with an output signal from a detection device disposed in or near said light emission portion or near said light transmission surface of said light emission portion and an image input into said liquid crystal display device.

19. A liquid crystal display apparatus according to claim 16, wherein a plurality of light emission units each integrating a plurality of said light emission portions are disposed, and quantity of light emission is controlled for each of said light emission units individually in accordance with an image input into said liquid crystal display device.

20. A liquid crystal display apparatus according to claim 17, wherein a plurality of light emission units each integrating a plurality of said light emission portions are disposed, and quantity of light emission is controlled for each of said light emission units individually in accordance with an image input into said liquid crystal display device.
